(19) United States
(12) Patent Application Publication
(10) Pub. No.: US 2026/0124687 A1
(43) Pub. Date: May 7, 2026

(54) SPINDLE, ROUTER APPARATUS AND CUTTING BIT

(71) Applicant: SAMSUNG ELECTRONICS CO., LTD., Suwon-si (KR)

(72) Inventors: Jeongeun AHN, Suwon-si (KR); Youngwan KIM, Suwon-si (KR); Youngrock LEE, Suwon-si (KR); Taehoon LEE, Suwon-si (KR)

(21) Appl. No.: 19/087,976

(22) Filed: Mar. 24, 2025

(30) Foreign Application Priority Data
Nov. 5, 2024 (KR) 10-2024-0155548

(51) Int. Cl. B23C 5/26; B23C 5/00; B23C 5/10; B23C 7/00

(52) U.S. Cl. CPC B23C 5/26; B23C 5/006; B23C 5/10; B23C 7/00

(57) ABSTRACT

Provided is a spindle, a router device, and a cutting bit. The spindle may include: a spindle body having an internal space; a rotary shaft in the internal space, and having a receiving space configured to receive one end of a cutting bit, the cutting bit including a plurality of fastening portions spaced apart from each other in a longitudinal direction of the cutting bit and a plurality of cutting portions disposed between the plurality of fastening portions and configured to cut a substrate; and a support head at one end of the spindle body, and including a collet connected to one end of the rotary shaft and configured to selectively fasten at least one fastening portion among the plurality of fastening portions.

### CROSS-REFERENCE TO RELATED APPLICATION(S)

This application claims benefit of priority to Korean Patent Application No. 10-2024-0155548, filed on Nov. 5, 2024 in the Korean Intellectual Property Office, the disclosure of which is incorporated herein by reference in its entirety.

### BACKGROUND

The present inventive concept relates to a spindle, a router apparatus, and a cutting bit used for cutting a substrate.

In general, in order to improve production efficiency in a substrate manufacturing process such as a printed circuit board, a routing process, or the like, of cutting and separating an array board in which a plurality of printed circuit boards are arranged on a single panel into a plurality of individual printed circuit boards using a substrate cutting device such as a router device, or the like, may be performed.

In the case of such a router device, a substrate is cut while a cutting bit is mounted on one end of a spindle, and a cutting portion of the cutting bit for cutting the substrate is a portion protruding from one end of the spindle by a certain length. When a service life of the cutting portion is completed, the cutting portion should be replaced with a new cutting bit. However, due to the cutting portion having a limited length of the cutting bit, the service life of the cutting bits is short, which causes a problem in that a replacement cycle thereof is shortened.

### SUMMARY

An aspect of the present inventive concept is to provide a spindle for extending a replacement cycle of a cutting bit.

An aspect of the present inventive concept is to provide a router device for extending a replacement cycle of a cutting bit.

An aspect of the present inventive concept is to provide a cutting bit for extending a replacement cycle of a cutting bit.

According to an aspect of the present inventive concept, provided is a spindle, the spindle including: a spindle body having an internal space; a rotary shaft in the internal space, and having a receiving space configured to receive one end of a cutting bit, the cutting bit including a plurality of fastening portions spaced apart from each other in a longitudinal direction of the cutting bit and a plurality of cutting portions disposed between the plurality of fastening portions and configured to cut a substrate; and a support head at one end of the spindle body, and including a collet connected to one end of the rotary shaft and configured to selectively fasten at least one fastening portion among the plurality of fastening portions.

According to another aspect of the present inventive concept, provided is a router device, the router device including: a cutting region in which a substrate is cut into a plurality of unit substrates; a spindle including a rotary shaft having a receiving space configured to receive one end of a cutting bit, the cutting bit including a plurality of fastening portions spaced apart from each other in a longitudinal direction of the cutting bit and a plurality of cutting portions disposed between the plurality of fastening portions and configured to cut the substrate, and at least one collet configured to selectively fasten at least one fastening portion among the plurality of fastening portions, wherein the substrate is cut into the plurality of unit substrates using one of the plurality of cutting portions in the cutting region; an adjustment region in which a fastening portion among the plurality of fastening portions of the cutting bit is adjusted so that the at least one fastening portion is selectively fastened to the at least one collet; and a transfer robot configured to move the spindle between the cutting region and the adjustment region while moving the spindle in a height direction, wherein the spindle is connected to the transfer robot.

According to another aspect of the present inventive concept, a cutting bit may include: a plurality of fastening portions spaced apart from each other in a longitudinal direction and configured to be fastened to a collet of a spindle; and a plurality of cutting portions disposed between the plurality of fastening portions and configured to cut a substrate.

### BRIEF DESCRIPTION OF DRAWINGS

The above and other aspects, features, and advantages of the present disclosure will be more clearly understood from the following detailed description, taken in conjunction with the accompanying drawings:

FIG. 1 is an example diagram illustrating a router device according to example embodiments of the present inventive concept;

FIG. 2 is an example diagram illustrating a spindle used in a router device according to example embodiments of the present inventive concept;

FIG. 3 is an example diagram illustrating a cutting bit according to example embodiments of the present inventive concept;

FIG. 4 is an example diagram illustrating a fastening structure of a support head of a spindle and a cutting bit according to example embodiments of the present inventive concept;

FIGS. 5 to 9 are example diagrams illustrating an operation process of a router device;

FIG. 10 is an example diagram illustrating a cutting bit according to other example embodiments of the present inventive concept; and

FIG. 11 is an example diagram illustrating a cutting bit according to other example embodiments of the present inventive concept.

### DETAILED DESCRIPTION

Hereinafter, example embodiments of the present inventive concept will be described with reference to the attached drawings.

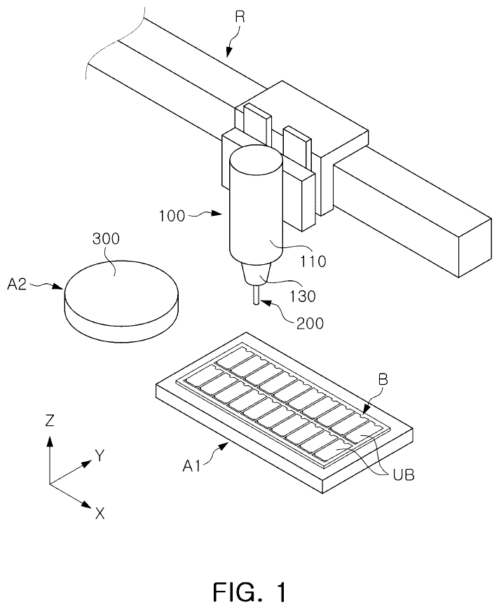

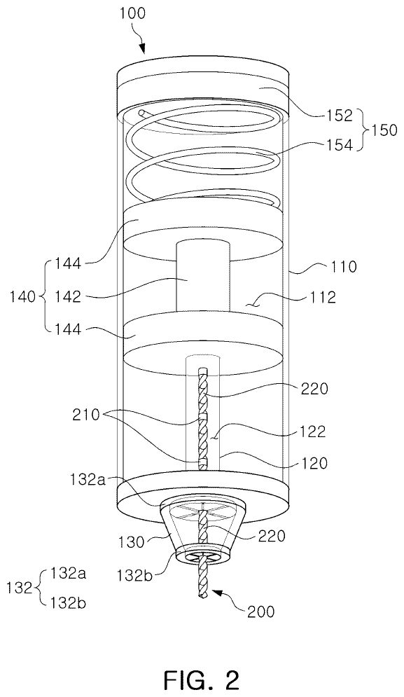

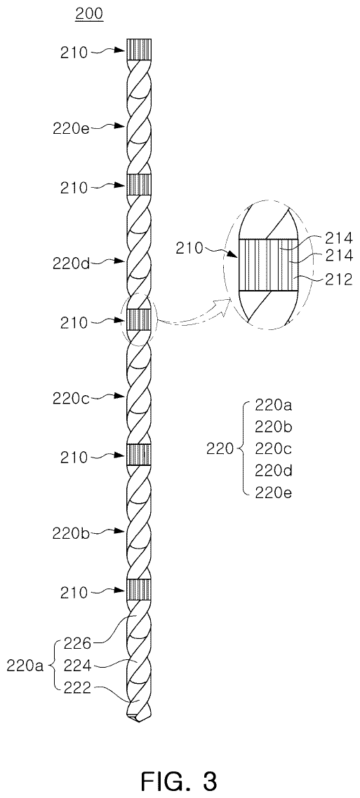

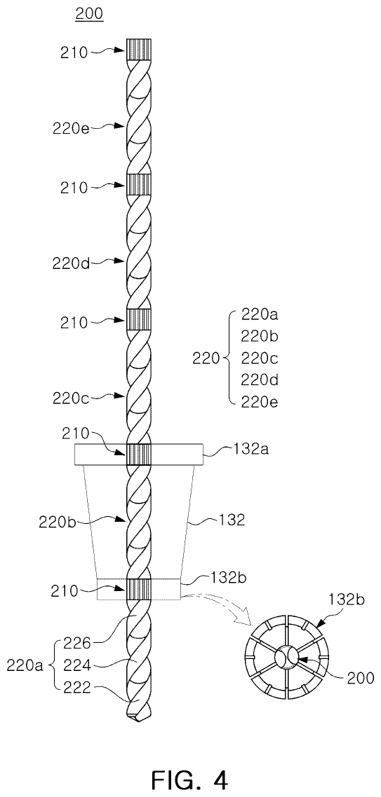

FIG. 1 is an example diagram illustrating a router device according to example embodiments of the present inventive concept, FIG. 2 is an example diagram illustrating a spindle used in a router device according to example embodiments of the present inventive concept, FIG. 3 is an example diagram illustrating a cutting bit according to example embodiments of the present inventive concept, and FIG. 4 is an example diagram illustrating a fastening structure of a support head of a spindle and a cutting bit according to example embodiments of the present inventive concept.

Referring to FIGS. 1 to 3, a router device according to example embodiments of the present inventive concept may include a spindle 100 used to cut a substrate B, an adjustment region A2, and a transfer robot R.

The substrate B may have a plurality of unit substrates UB arranged thereon. For example, the substrate B may be an array printed circuit board having a plurality of unit printed circuit boards arranged thereon. A bridge (not shown) may be disposed between the adjacent plurality of unit substrates UB, and the substrate B may be cut along the bridge using a cutting bit 200 to be described below.

The spindle 100 may be connected to a transfer robot R and may be moved by the transfer robot R. For example, the spindle 100 may be moved by the transfer robot R in a first direction X, a second direction Y perpendicular to the first direction X, and a third direction Z perpendicular to the first direction X and the second direction Y. Here, the first direction X may be a longitudinal direction of the substrate B illustrated in FIG. 1, the second direction Y may be a width or lateral direction of the substrate B, and the third direction may be a height direction Z, but example embodiments thereof are not limited thereto.

A cutting bit 200 for cutting a substrate B may be mounted at a lower end of the spindle 100. The cutting bit 200 may be fastened to a collet 132 of a support head 130 of a spindle 100 to be described below.

The cutting bit 200 may be implemented in various forms. In example embodiments, the cutting bit 200 may include a plurality of fastening portions 210 and a plurality of cutting portions 220. The plurality of fastening portions 210 may be disposed to be spaced apart from each other in the longitudinal direction of the cutting bit 200 and may be fastened to a collet 132 of a support head 130 to be described below. The plurality of cutting portions 220 may be disposed between the plurality of fastening portions 210 and may cut the substrate B. The cutting portion 220 of the cutting bit 200 may cut the substrate B into a plurality of unit substrates UB using an outer peripheral surface. Each of the plurality of cutting portions 220 may include a plurality of cutting ends in the longitudinal direction of the cutting bit 200. For example, each of the plurality of cutting portions 220 may include at least two cutting ends in the longitudinal direction of the cutting bit 200. In example embodiments, as illustrated in FIG. 3, each of the plurality of cutting portions 220 may include a first cutting end 222, a second cutting end 224, and a third cutting end 226, sequentially disposed from one side to the other side thereof in the longitudinal direction of the cutting bit 200. One cutting portion 220 including a first cutting end 222, a second cutting end 224, and a third cutting end 226 may be disposed between each of the two adjacent fastening portions 210 among the plurality of fastening portions 210. The first cutting end 222, the second cutting end 224, and the third cutting end 226 may be sequentially positioned from a lower side to an upper side thereof while the fastening portion 210 of the cutting bit 200 is fastened to a collet 132 of the support head 130 of the spindle 100. Accordingly, while a corresponding fastening portion 210 among a plurality of fastening portion 210 is fastened to the collet 132 of the support head 130 of the spindle 100, a substrate B located below the cutting bit 200 may be cut using one of the first cutting end 222, the second cutting end 224, and the third cutting end 226 of the cutting portion 220. In example embodiments, while a corresponding fastening portion 210 among a plurality of fastening portion 210 is fastened to the collet 132 of the support head 130 of the spindle 100, a substrate B disposed below the cutting bit 200 may be cut by sequentially using the first cutting end 222, the second cutting end 224, and the third cutting end 226 of the cutting portion 220. The cutting bit 200 may include at least two cutting portions 220. Here, for convenience of explanation, the cutting portions 220 sequentially disposed from the lower side to the upper side while the cutting bit 200 is mounted on the spindle 100 by fastening the fastening portion 210 to the collet 132 may be referred to as a first cutting portion 220a, a second cutting portion 220b, a third cutting portion 220c, . . . n^{th} cutting portion, respectively. Here, the n^{th} cutting portion refers to a cutting portion disposed on the uppermost side among the plurality of cutting portions 220. In example embodiments, as illustrated in FIG. 3, the n^{th} cutting portion may be a fifth cutting portion 220e, and the cutting bit 200 may include a first cutting portion 220a, a second cutting portion 220b, a third cutting portion 220c, a fourth cutting portion 220d, and a fifth cutting portion 220e. When cutting a substrate B disposed below the cutting bit 200, first, a first cutting end 222 of the first cutting portion 220a is used and when a service life of the first cutting end 222 of the first cutting portion 220a is completed, a second cutting end 224 of the first cutting portion 220a is used. Then, when a service life of the second cutting end 224 of the first cutting portion 220a is completed, the third cutting end 226 of the first cutting portion 220a is used. When the service lives of all cutting ends 222, 224, and 226 of the first cutting portion 220a is completed, the fastening portion 210 fastened to the collet 132 of the support head 130 of the spindle 100 may be released and another corresponding fastening portion 210 may be fastened to the collet 132 so that the substrate B may be cut through the second cutting portion 220b disposed above the first cutting portion 220a. Likewise, the second cutting portion 220b may sequentially use the first cutting end 222, the second cutting end 224, and the third cutting end 226, sequentially disposed from a lower side to an upper side thereof, and the usage method of the third cutting portion 2220c, the fourth cutting portion 220d, and the fifth cutting portion 220e may be the same as the usage method of the first cutting portion 220a and the second cutting portion 220b, so the description thereof is omitted in the interest of brevity.

In example embodiments, to improve the fastening strength between the collet 132 of the support head 130 of the spindle 100 and the cutting bit 200, each of the plurality of fastening portions 210 may have an outer peripheral surface including at least one of a flat surface and an unevenness portion or uneven portion. For example, as illustrated in FIG. 3, each of the plurality of fastening members 210 may have an outer peripheral surface including a flat surface 212 and a protrusion 214. A plurality of flat surfaces 212 may be disposed in a circumferential direction on the outer peripheral surface of the fastening portion 210. Furthermore, in order to increase the frictional force between the fastening portion 210 and the collet 132 of the support head 130 of the spindle 100, the unevenness portion 214 may be formed on the flat surface 212, and the size and shape of the unevenness portion 214 may be formed in various forms. For example, a plurality of unevenness portions 214 or one unevenness portion 214 arranged in a certain size and shape on a flat surface 212 may be formed, but example embodiments thereof are not particularly limited thereto. Accordingly, the fastening portion 210 may be stably fastened to the collet 132 of the support head 130 of the spindle 100 through a structure in which a plurality of fastening portions 210 include a flat surface 212 and the unevenness portion 214.

In example embodiments, the two adjacent fastening portions 210 among the plurality of fastening portions 210 may have the same separation distance therebetween. Accordingly, the manufacturing and processing of the cutting bit 200 may be improved, and the fastening of the support head 130 of the spindle 100 to the collet 132 may also be easily performed, and a detailed description thereof will be described below.

The spindle 100 may be implemented in various embodiments. In example embodiments, the spindle 100 may include a spindle body 110, a rotary shaft 120, and a support head 130.

The spindle body 110 may have or define an internal space 112 for receiving various components including a rotary shaft 120, or the like. The spindle body 110 may be formed in various shapes, and for example, may be formed in a cylindrical shape in which the internal space 112 is formed, but example embodiments thereof are not limited thereto.

The rotary shaft 120 may be disposed in the internal space 112 of the spindle body 110. The rotary shaft 120 may have a receiving space 122 into which a portion of a cutting bit 200 is received thereinside. The receiving space 122 may be open from the inside of the rotary shaft 120 to one end of the rotary shaft 120. One end of the cutting bit 200 may be inserted into the receiving space 122 through one end of the rotary shaft 120 and received. In addition, in example embodiments, one end of the cutting bit 200 inserted into the receiving space 122 of the rotary shaft 120 may have the fastening portion 210 disposed thereon. Accordingly, a disposition structure of the cutting portion 220 for the cutting bit 200 may be optimized to increase a cutting area of the cutting portion 220, and further, an overall service life of the cutting bit 200 may be improved and a replacement cycle of the cutting bit 200 may be effectively increased.

The spindle 100 may include at least one collet 132 disposed at one end of the spindle 100 to fasten the cutting bit 200. In example embodiments, the support head 130 may include at least one collet 132 disposed at one end (e.g., a first end) of the spindle body 110 and connected to one end of the rotary shaft 120. The collet 132 may press an outer peripheral surface of the fastening portion 210 of the cutting bit 200 inwardly of a radial direction to fasten the fastening portion 210 of the cutting bit 200, or release the pressure of the outer peripheral surface of the fastening portion 210 outwardly of the redial direction to detach the fastening portion 210 of the cutting bit 200 from the collet 132. The collet 132 may selectively fasten at least one of the plurality of fastening portions 210 of the cutting bit 200. In example embodiments, the support head 130 may include at least two collets correspondingly fastening at least two of the plurality of fastening portions 210 of the cutting bit 200, wherein the at least two collets may be aligned in an axial direction of the rotary shaft 120. The support head 130 may more stably fasten the cutting bit 200 through a structure including at least two collets. In particular, in order to increase the replacement cycle and service life of the cutting bit 200, even in the case of a cutting bit having a slim structure having a reduced diameter or a structure having a longer length of the cutting bit 200, the cutting bit 200 can be stably fastened, and during a cutting process of the cutting bit 200, the occurrence of warpage or breakage due to the slimming of the cutting bit 200 may be effectively prevented. In example embodiments, as illustrated in FIGS. 2 to 4, the support head 130 may include a first collet 132a and a second collet 132b aligned in an axial direction of the rotational axis or the rotary shaft 120. The first collet 132a and the second collet 132b may respectively correspondingly fasten any two adjacent fastening portions among the plurality of fastening portions 210. The first collet 132a and the second collet 132b may be disposed to be spaced apart from each other in the axial direction of the rotary shaft 120. The first collet 132a may be disposed at one end of the support head 130, and the second collet 132b may be disposed at the other (opposite) end of the support head 130. One end (e.g., a first end) of the support head 130 may be disposed at one end of the spindle body 110, and the other end (e.g., a second, opposite end) of the support head 130 may be disposed to face one end of the support head 130. A separation distance between the first collet 132a and the second collet 132b may be equal to a separation distance between any two adjacent fastening portions 210 of the cutting bit 200. Accordingly, the manufacturing and processing of the cutting bit 200 may be improved, and the fastening portion of the cutting bit 200 with the first collet 132a and the second collet 132b may be easily and rapidly adjusted. The support head 130 may be formed in various shapes. In example embodiments, the support head 130 may have a tapered shape in which the outer peripheral surface gradually decreases in width or diameter from one end of the support head 130 to the other end of the support head 130. In this case, a size (e.g., width or diameter) of the first collet 132a may be configured to be larger than a size (e.g., width or diameter) of the second collet 132b. The first collet 132a and the second collet 132b may stably fasten the cutting bit 200 and disperse stress on the fastening portion of the cutting bit 200, thereby effectively preventing warpage or breakage due to stress concentration on the fastening portion of the cutting bit 200. In addition, the first collet 132a and the second collet 132b may secure the centering of the cutting bit 200 during the rotation state of the spindle 100 or during the process in which the cutting bit 200 cuts the substrate B, and may effectively prevent the cutting bit 200 from shaking or twisting or breaking due to stress concentration.

In example embodiments, the spindle 100 may also include a rotary driving device 140 and an adjusting device 150.

The rotary driving device 140 may be connected to the rotary shaft 120 and provide rotational force to the rotary shaft 120 so that the rotary shaft 120, the support head 130, and the cutting bit 200 may rotate together at high speed. The rotary driving device 140 may be implemented in various shapes and driving methods without particular limitations as long as it has a configuration for driving the rotary shaft 120 to rotate. In example embodiments, the rotary driving device 140 may include a rotor 142 disposed in an internal space 112 of a spindle body 110 and a bearing 144 supporting the rotor 142. The rotor 142 may be connected to a driving motor (not shown) and the rotary shaft 120 and may rotate together with the rotary shaft 120 by driving the driving motor. The bearing 144 may be disposed between both ends of the rotor 142 and an inner wall of the spindle body 110 and may guide and support a rotational movement of the rotor 142.

The adjusting device 150 may be configured to adjust fastening and releasing operations of the collet 132. The adjusting device 150 may be implemented in various forms and adjusting methods without particular limitation as long as it is configured to adjust the fastening and releasing operations of the first collet 132a and the second collet 132b. In example embodiments, the adjusting device 150 may include a cylinder 152 and an elastic member 154 elastically supporting the cylinder 152. The cylinder 152 may be disposed to be elevatable on the other end (e.g., a second, opposite end) of the spindle body 110, and may adjust the fastening and releasing operations of the first collet 132a and the second collet 132b. In order for the cylinder 152 to adjust the fastening and releasing operations of the first collet 132a and the second collet 132b, a power transmission structure (not shown) may be disposed between the cylinder 152 and the first collet 132a and the second collet 132b. By a lowering operation of the cylinder 152, the first collet 132a and the second collet 132b may perform a fastening and releasing operation, so that the cutting bit 200 may be mounted thereon or the fastening portion of the cutting bit 200 may be adjusted, and when the cylinder 152 is raised to an original position thereof, the first collet 132a and the second collet 132b may perform a fastening operation, so that the cutting bit 200 may be fastened and fixed to the spindle 100. A structure of such a cylinder 152 is similar to the structure of a cylinder configured to adjust the fastening and releasing operations of a conventional collet, and a detailed description thereof is omitted in the interest of brevity. The elastic member 154 may elastically support the cylinder 152 in an internal space 112 of the spindle body 110. The elastic member 154 may be disposed between the cylinder 152 and the bearing 144 in the internal space 112 of the spindle body 110 and may be a coil spring. The elastic member 154 may provide elastic force so that the cylinder 152 tends to return to the original position. However, the present inventive concept is not limited to the structure of the adjusting device having the configuration described above, and may be implemented in other example embodiments.

A router device according to example embodiments of the present inventive concept may include a cutting region A1 and an adjustment region A2.

The cutting region A1 is a region in which the substrate B is cut into a plurality of unit substrates UB. The spindle 100 may be transferred to a cutting region A1 by a transfer robot R, and a cutting process of cutting a substrate B into a unit substrate UB using a cutting bit 200 mounted on the spindle 100 in the cutting region A1 may be performed. The substrate B may be cut into a unit substrate UB using one of the plurality of cutting portions 220 of the cutting bit 200 in the cutting region A1.

The adjustment region A2 is a region in which the fastening portion of the cutting bit 200 is adjusted. In the adjustment region A2, the fastening portion of the cutting bit 200 may be adjusted so that at least one fastening portion 210 of the cutting bit 200 is selectively fastened to at least one collet 132. In example embodiments, the fastening portion of the cutting bit 200 may be adjusted so that two adjacent fastening portions 210 among the plurality of fastening portions 210 of the cutting bit 200 in the adjustment region A2 are fastened to the first collet 132a and the second collet 132b. Accordingly, the cutting process may be performed by selecting a cutting portion 220 used to cut the substrate B. That is, by adjusting the fastening portion of the cutting bit 200, one of the first cutting portion 220a, the second cutting portion 220b, the third cutting portion 220c, and the fourth cutting portion 220d of the cutting bit 200, as shown in FIG. 3 may be selected and used to cut the substrate B. In example embodiments, a support table 300 on which the other end of the cutting bit 200 is supported may be disposed in the adjustment region A2 to adjust the fastening portion of the cutting bit 200. The spindle 100 may be moved between the cutting region A1 and the adjustment region A2 by the transfer robot R and may also be moved in a height direction Z.

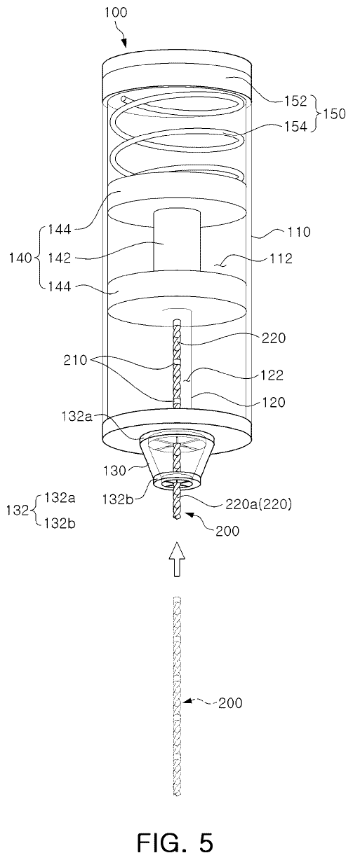

FIGS. 5 to 9 are example diagrams illustrating an operation process of a router device.

Hereinafter, the operation process of the router device according to example embodiments of the present inventive concept is described with reference to FIGS. 5 to 9.

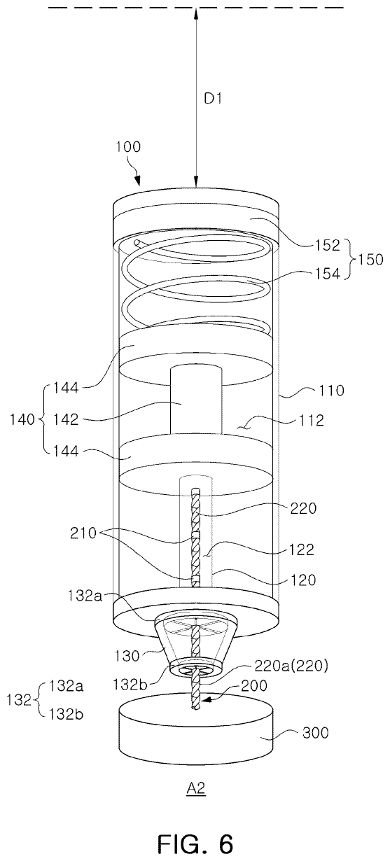

As shown in FIG. 5, the cutting bit 200 is mounted on the spindle 100 by fastening two adjacent fastening portions 210 of the cutting bit 200 to a first collet 132a and a second collet 132b, which are released by a lowering movement of the cylinder 152 of the spindle 100. Here, two fastening portions 210 adjacent to an upper portion of the first cutting portion 220a of the cutting bit 200 may be fastened to the first collet 132a and the second collet 132b to cut the substrate B using the first cutting portion 220a disposed in the lowermost portion of the cutting bit 200. The cutting bit 200 may be mounted in the adjustment region A2 as shown in FIG. 6. That is, in the adjustment region A2, the position of the spindle 100 may be adjusted in the height direction Z by a transfer robot R by a first set distance D1, so that when the first collet 132a and the second collet 132b of the spindle 100 are released, the lower portion of the cutting bit 200 may be supported on an upper surface of the support table 300, and accordingly, the two adjacent fastening portions 210 adjacent to the upper portion of the first cutting portion 220a of the cutting bit 200 may be positioned to correspond to the first collet 132a and the second collet 132b, respectively, and fastened.

However, the present inventive concept is not limited thereto, and may proceed in the cutting region A1 or in a region other than the cutting region A1 and the adjustment region A2.

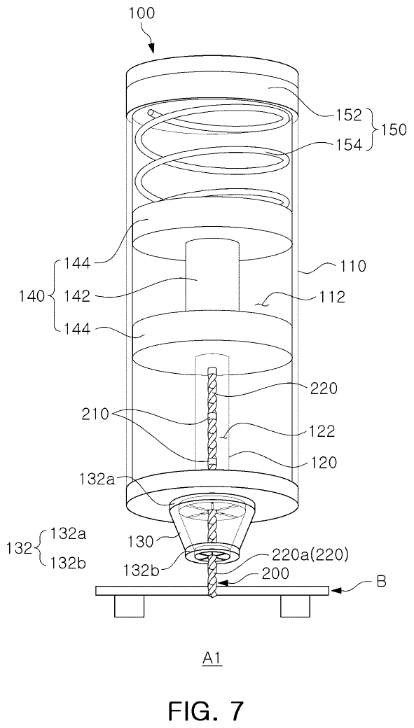

Next, as shown in FIG. 7, the spindle 100 and the cutting bit 200 may be transferred from the adjustment region A2 to the cutting region A1 by the transfer robot R. In the cutting region A1, a cutting process for cutting the substrate B into a unit substrate UB using the first cutting portion 220a disposed in a lowermost portion of the cutting bit 200 while the spindle 100 and the cutting bit 200 rotate together may be performed. A movement trajectory of the spindle 100 and cutting bit 200 may be preset, and the spindle 100 and cutting bit 200 may be moved in a first direction X, a second direction Y, or a third direction (height direction Z) along the movement trajectory by a transfer robot R. The cutting bit 200 may cut the substrate B using an outer peripheral surface of the first cutting portion 220a. When a service life of the first cutting portion 220a of the cutting bit 200 is completed during the process of cutting the substrate B, the spindle 100 and the cutting bit 200 may be transferred from the cutting region A1 to the adjustment region A2 again by the transfer robot R.

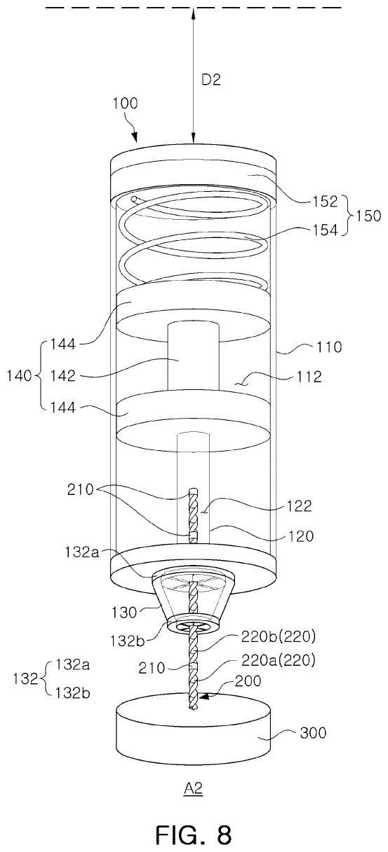

As illustrated in FIG. 8, in the adjustment region A2, the spindle 100 is positioned in the height direction Z by a second set distance D2 by the transfer robot R, so that when the first collet 132a and the second collet 132b of the spindle 100 are released, a lower portion of the cutting bit 200 may be supported on an upper surface of the support table 300, and accordingly, two fastening portions 210 adjacent to an upper portion of the second cutting portion 220b of the cutting bit 200 may be positioned and fastened to correspond to the first collet 132a and the second collet 132b, respectively.

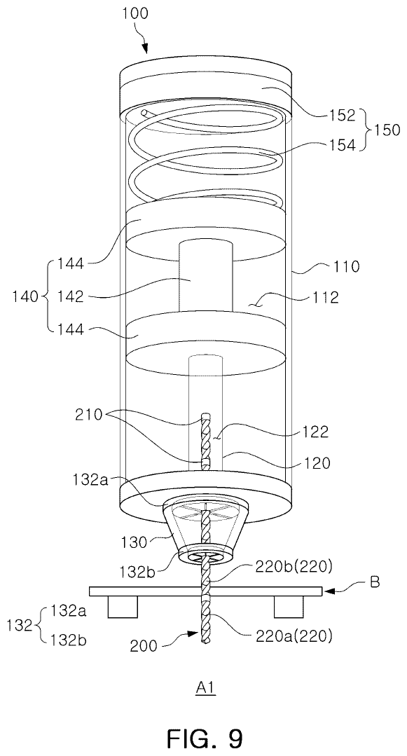

A set distance (including the first set distance D1 and the second set distance D2) by which the spindle 100 moves in the height direction Z by the transfer robot R in the adjustment region A2 may be determined according to a fastening portion to be fastened to the first collet 132a and the second collet 132b among the plurality of fastening portions 210 of the cutting bit 200. In other words, the setting distance may be determined according to a cutting portion 220 of the cutting bit 200 to be used. The second setting distance D2 may be smaller than the first setting distance D1. After the fastening portion of the cutting bit 200 is adjusted in the adjustment region A2, as shown in FIG. 9, the spindle 100 and the cutting bit 200 may be transferred back from the adjustment region A2 to the cutting region A1 by the transfer robot R. In the cutting region A1, a cutting process in which the spindle 100 and the cutting bit 200 rotate together in the cutting region A1 to cut the substrate B into a unit substrate UB by using an outer circumferential surface of the second cutting portion 220b disposed above the first cutting portion 220a of the cutting bit 200 may be continuously performed. When a service life of the second cutting portion 220b of the cutting bit 200 is completed during the process of cutting the substrate B, the spindle 100 and the cutting bit 200 may be transferred from the cutting region A1 to the adjustment region A2 again by the transfer robot R, and in the same manner as the adjustment method described above, the fastening portion of the cutting bit 200 may be adjusted and the third cutting portion 220c and the fourth cutting portion 220d may be sequentially used to cut the substrate B. Accordingly, the service life and replacement cycle of the cutting bit 200 may be extended, thereby reducing manufacturing costs.

Next, when the service life of the fourth cutting portion 220d of the cutting bit 220 is completed, the fifth cutting portion 220e may be selectively used, and when the fifth cutting portion 220e is used, the substrate may be cut while a fastening portion disposed above the fifth cutting portion is fastened using one of the first collet and the second collet (for example, the second collet in FIG. 2). When the entire cutting portion of the cutting bit 200 is used up, the used cutting bit 200 is removed from the spindle 100 and a new cutting bit is mounted on the spindle 100 so that the cutting process and the adjustment operation for the fastening portion of the cutting bit 200 may be performed as shown in FIGS. 5 to 9.

In the example embodiments, the support head 130 has been described as an embodiment including a first collet 132a and a second collet 132b, but the present inventive concept is not limited thereto, and one collet or more than two collets may be implemented.

In the example embodiments, it is described as including the cutting bit 200 includes a first cutting portion 220a, a second cutting portion 220b, a third cutting portion 220c, a fourth cutting portion 220d, and a fifth cutting portion 220e, and each of the first to fifth cutting portions 220a, 220b, 220c, 220d, and 220e includes a first cutting end 222, a second cutting end 224, and a third cutting end 226, but the present inventive concept is not limited thereto. If the cutting bit 200 is configured to include two cutting portions, it can be changed into various embodiments, and it is also possible to change each of the cutting portions to include one or two cutting portions or four or more cutting portions depending on the size of the cutting bit, such as a length and diameter thereof.

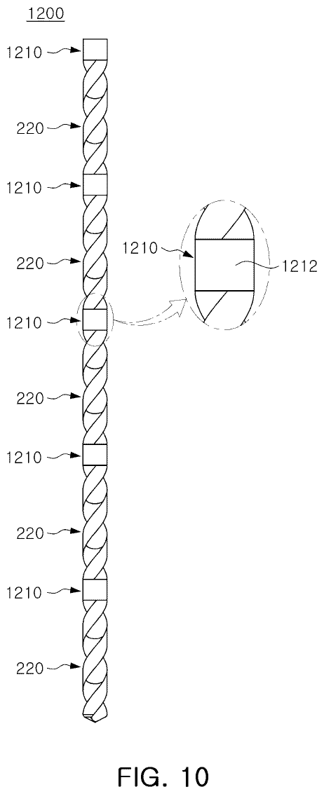

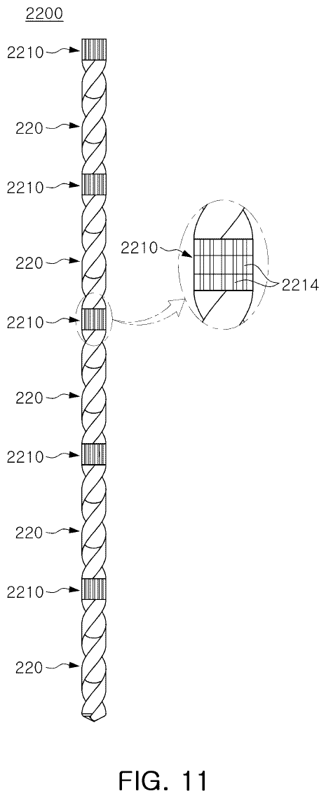

In addition, in the example embodiments described above, the structure in which the outer peripheral surface of each of the plurality of fastening portions 210 includes a flat surface 212 and unevenness portion 214 has been described as an example, but the present inventive concept is not limited thereto, and may be formed in various shapes, and other example embodiments will be described with reference to FIGS. 10 and 11.

FIG. 10 is an example diagram illustrating a cutting bit according to other example embodiments of the present inventive concept.

Referring to FIG. 10, a cutting bit 1200 may include a plurality of fastening portions 1210 and a plurality of cutting portions 220. The plurality of fastening portions 1210 may be disposed to be spaced apart from each other in a longitudinal direction of the cutting bit 1200 and may be fastened to a collet of a spindle. The plurality of cutting portions 220 are disposed between the plurality of fastening parts 1210 and may cut a substrate B. Here, the configuration of the plurality of cutting portions 220 is the same as the configuration of the cutting portion 220 described in the above example embodiments, so a detailed description thereof is omitted in the interest of brevity.

An outer peripheral surface of each of the plurality of fastening portions 1210 may include a flat surface 1212. That is, unlike the configuration of the fastening portion 210 having an outer peripheral surface including a flat surface 212 and the unevenness portion 214 in the example embodiments described above, in other example embodiments, the outer peripheral surface of each of the fastening portions 1210 may not include the unevenness portion and may include only a flat surface 1212. Accordingly, it can be stably fastened to a collet of the spindle through the flat surface 1212 of the plurality of fastening portions 1210.

FIG. 11 is an example diagram illustrating a cutting bit according to other example embodiments of the present inventive concept.

Referring to FIG. 11, a cutting bit 2200 may include a plurality of fastening portions 2210 and a plurality of cutting portions 220. The plurality of fastening portions 2210 may be disposed to be spaced apart from each other in a longitudinal direction of the cutting bit 2200 and may be fastened to a collet of the spindle. The plurality of cutting portions 220 may be disposed between the plurality of fastening portions 2210 and may cut the substrate B. Here, the configuration of the plurality of cutting parts 220 is the same as the configuration of the cutting portion 220 described in the example embodiments described above, so a detailed description thereof is omitted in the interest of brevity.

Each of the plurality of fastening portions 2210 may have an outer peripheral surface having an unevenness portion 2214. That is, each of the plurality of fastening portions 2210 may have an outer peripheral surface having an unevenness portion 2214. That is, unlike the configuration of the fastening portion 210 having an outer peripheral surface including a flat surface 212 and unevenness portion 214 in the example embodiments described above, in other example embodiments, the outer peripheral surface of each of the fastening portions 2210 may not include a flat surface but may include only unevenness portions 2214. Accordingly, it can be stably fastened to the collet of the spindle through the unevenness portions 2214 of the plurality of fastening portions 2210.

The cutting bits 1200 and 2200 according to the example embodiments described with reference to FIGS. 10 and 11 may be applied to the same configuration of the cutting bit 200 except for the configuration distinguished above, and may also be used in the same manner in the spindle 100 and the router device described with reference to FIGS. 1 to 9.

As set forth above, according to example embodiments of the present inventive concept, a spindle, a router device, and a cutting bit, for extending a replacement cycle of the cutting bit, may be provided.

The various and advantageous advantages and effects of the present inventive concept are not limited to the above description, and may be more easily understood in the course of describing the specific embodiments of the present inventive concept.

While example embodiments have been shown and described above, it will be apparent to those skilled in the art that modifications and variations could be made without departing from the scope of the present inventive concept as defined by the appended claims.

What is claimed is:

1. A spindle, comprising:
a spindle body having an internal space;
a rotary shaft in the internal space, and having a receiving space configured to receive one end of a cutting bit, the cutting bit including a plurality of fastening portions spaced apart from each other in a longitudinal direction of the cutting bit and a plurality of cutting portions disposed between the plurality of fastening portions and configured to cut a substrate; and
a support head at one end of the spindle body, and including a collet connected to one end of the rotary shaft and configured to selectively fasten at least one fastening portion among the plurality of fastening portions.

2. The spindle of claim 1, wherein the support head includes at least two collets aligned in an axial direction of the rotary shaft and configured to correspondingly fasten at least two fastening portions among the plurality of fastening portions.

3. The spindle of claim 1, wherein the support head includes a first collet and a second collet aligned in an axial direction of the rotary shaft and configured to correspondingly fasten any two fastening portions adjacent each other, among the plurality of fastening portions.

4. The spindle of claim 3, wherein the first collet is disposed at a first end of the support head at one end of the spindle body, and the second collet is disposed at a second, opposite end of the support head.

5. The spindle of claim 3, wherein the support head has an outer circumferential surface gradually decreasing in width or diameter from a first end of the support head to a second, opposite end of the support head.

6. The spindle of claim 1, wherein the support head includes a rotary driving device connected to the rotary shaft configured to provide rotational force and an adjusting device configured to adjust fastening and releasing operations of the collet.

7. The spindle of claim 6, wherein the rotary driving device includes a rotor in the internal space connected to the rotary shaft, and a bearing in the internal space and configured to support the rotor.

8. The spindle of claim 6, wherein the adjusting device comprises
a cylinder elevatable on the other end of the spindle body and configured to adjust the fastening and releasing operations of the collet; and
an elastic member configured to elastically support the cylinder in the internal space and to provide elastic force so that the cylinder tends to return to an original position thereof.

9. A router device, comprising:
a cutting region in which a substrate is cut into a plurality of unit substrates;
a spindle including a rotary shaft having a receiving space configured to receive one end of a cutting bit, the cutting bit including a plurality of fastening portions spaced apart from each other in a longitudinal direction of the cutting bit and a plurality of cutting portions disposed between the plurality of fastening portions and configured to cut the substrate, and at least one collet configured to selectively fasten at least one fastening portion among the plurality of fastening portions, wherein the substrate is cut into the plurality of unit substrates using one of the plurality of cutting portions in the cutting region;
an adjustment region in which a fastening portion among the plurality of fastening portions of the cutting bit is adjusted so that the at least one fastening portion is selectively fastened to the at least one collet; and
a transfer robot configured to move the spindle between the cutting region and the adjustment region while moving the spindle in a height direction, wherein the spindle is connected to the transfer robot.

10. The router device of claim 9, wherein a support table on which the other end of the cutting bit is disposed in the adjustment region.

11. The router device of claim 9, wherein the spindle includes a first collet and a second collet at one end of the spindle, and aligned in an axial direction of the rotary shaft, and configured to correspondingly fasten any two adjacent fastening portions, among the plurality of fastening portions.

12. The router device of claim 11, wherein the first collet and the second collet are spaced apart from each other in the axial direction of the rotary shaft.

13. The router device of claim 12, wherein a separation distance between the first collet and the second collet is the same as a separation distance between any two adjacent fastening portions among the plurality of fastening portions.

14. The router device of claim 9, wherein the router device comprises
a rotary driving device connected to the rotary shaft and configured to provide rotational force, and an adjusting device configured to adjust fastening and releasing operations of the at least one collet.

15. The router device of claim 14, wherein the rotary shaft is in an internal space of the spindle, and
the rotary driving device includes a rotor and a bearing in the internal space with the rotor connected to the rotary shaft and the bearing supporting the rotor.

16. The router device of claim 15, wherein the adjusting device comprises
a cylinder elevatable on the other end of the spindle and configured to adjust the fastening and releasing operations of the at least one collet; and
an elastic member between the cylinder and the bearing in the internal space and configured to provide elastic force so that the cylinder tends to return to an original position thereof.

17. A cutting bit, comprising:
a plurality of fastening portions spaced apart from each other in a longitudinal direction and configured to be fastened to a collet of a spindle; and
a plurality of cutting portions disposed between the plurality of fastening portions and configured to cut a substrate.

18. The cutting bit of claim 17, wherein each of the plurality of fastening portions has an outer peripheral surface including at least one of a flat surface and an uneven portion.

19. The cutting bit of claim 17, wherein two adjacent fastening portions among the plurality of fastening portions have the same separation distance.

20. The cutting bit of claim 17, wherein each of the plurality of cutting portions includes a plurality of cutting ends arranged in the longitudinal direction.
